(19) United States
(12) Patent Application Publication
(10) Pub. No.: US 2009/0260646 A1
(43) Pub. Date: Oct. 22, 2009

(54) Fiber-Containing Product for Hair and Head Dressing Product Formed Therefrom

(75) Inventor: Toshiyuki Masuda, Hyogo (JP)

Correspondence Address: HAMRE, SCHUMANN, MUELLER & LARSON, P.C., P.O. BOX 2902, MINNEAPOLIS, MN, 55402-0902, US

(73) Assignee: Kaneka Corporation, Osaka-shi, Osaka (JP)

(21) Appl. No.: 11/991,865

(22) PCT Filed: Sep. 8, 2006
(86) PCT No.: PCT/JP2006/317844

§ 371 Date: Mar. 12, 2008

(30) Foreign Application Priority Data
Sep. 13, 2005 (JP) 2005-265844

(51) Int. Cl. A41G 3/00; C08L 89/00; A41G 5/00

(52) U.S. Cl. 132/53; 524/21

(57) ABSTRACT

Disclosed is a fiber for use as hair which has touch/shine like a hair, excellent curl-retaining property and flame retardancy. Also disclosed is a head-dressing product produced using the fiber. The fiber comprises (A) 90 to 10 parts by weight of polyester fiber and (B) 10 to 90 parts by weight of a reproduced collagen fiber containing an aluminum compound. Preferably, the aluminium compound is an aluminium salt and is contained in an amount of 8 to 20% by weight in terms of aluminium oxide. The polyester fiber may contain a flame retarder.

### TECHNICAL FIELD

The present invention relates to a fiber-containing product for hair having improved flame retardancy. Further, the present invention relates to a head dressing product that includes the fiber-containing product for hair.

### BACKGROUND ART

Head dressing products such as wigs are made using human hair and synthetic fibers. Human hair has the disadvantage that it has water absorbency, and thus when a curl is applied, the curl tends to be stretched out, resulting in a large curl diameter due to absorption of water. In short, human hair has poor shape-retaining capability. Human hair particularly has difficulty retaining its shape when washed.

Patent Document 1 discloses a wig that is made using human hair and a fiber containing polyester fiber, and describes that the wig has an improved curl-retaining capability. Further, Patent Document 2 discloses a fiber-containing product for hair made of human hair and a fiber containing polyester fiber that is made flame retardant, and describes that curl-retaining capability is improved while maintaining flame retardancy.

Unprocessed human hair has some degree of flame retardancy. However, human hair undergoes several steps of treatment such as removal of hair cuticle through a chemical treatment, sterilization, decolorization, dyeing, imparting shine, etc. before it is used as a head dressing product. Accordingly, human hair is susceptible to damage during these steps, and also various additives are included. As a result, it has been found that processed human hair has poor flame retardancy.

Polyester is highly flammable. The addition of a flame retardant to polyester improves flame retardancy, which may suppress ignition, combustion and degradation of heat resistance, but problems may arise such as melting and dripping.
Patent Document 1: JP 3021160 U
Patent Document 2: WO 2005/037000 A1

### DISCLOSURE OF INVENTION

### Problem to be Solved by the Invention

It is an object of the present invention to provide a fiber-containing product for hair that has the same texture and luster as those of human hair, excellent shape-retaining capability, such as curl-retaining capability, and flame retardancy although it is chemical fiber (artificial fiber). Another object of the present invention is to provide a head dressing product that is made of fiber-containing product for hair that has the same texture and luster as those of human hair, excellent shape-retaining capability, such as curl-retaining capability, and flame retardancy although it is chemical fiber (artificial fiber).

### Means for Solving Problem

The present inventors have found that the objects of the present invention are achieved by using a polyester-based fiber and a regenerated collagen fiber containing an aluminum salt as disclosed by WO 2001-000920 or U.S. Pat. No. 6,749,642. More specifically, the present invention relates to a fiber and a head dressing product as described below.

(1) A fiber-containing product for hair including 90 to 10 parts by weight of polyester-based fiber (A) and 10 to 90 parts by weight of regenerated collagen fiber (B) that includes an aluminum compound, the total of the (A) and the (B) being 100 parts by weight.

(2) The fiber-containing product for hair according to (1), wherein the polyester-based fiber (A) is a polyester-based fiber formed from at least one polyester (C) selected from the group consisting of polyalkylene terephthalate, copolymerized polyester that includes polyalkylene terephthalate as a main component, and a polymer alloy that includes polyester as a main component.

(3) The fiber-containing product for hair according to (2), wherein the polyester (C) is at least one polymer selected from the group consisting of polyethylene terephthalate, polypropylene terephthalate, polybutylene terephthalate, polyester that includes polyethylene terephthalate as a main component and is copolymerized with ethylene glycol ether of bisphenol A, polyester that includes polyethylene terephthalate as a main component and is copolymerized with 1,4-cyclohexanedimethanol, polyester that includes polyethylene terephthalate as a main component and is copolymerized with dihydroxyethyl 5-sodium sulfoisophthalate, a polymer alloy of polyethylene terephthalate and polyethylene naphthalate, a polymer alloy of polyethylene terephthalate and polyarylate, and a polymer alloy of polyethylene terephthalate and polycarbonate.

(4) The fiber-containing product for hair according to any one of (1) to (3), wherein the polyester-based fiber (A) has a heat shrinkage factor at 180° C. of 5% or less.

(5) The fiber-containing product for hair according to any one of (1) to (4), wherein the regenerated collagen fiber (B) is a regenerated collagen fiber that includes 8 to 20 wt % of an aluminum compound on an aluminum oxide basis.

(6) The fiber-containing product for hair according to any one of (1) to (5), wherein the regenerated collagen fiber (B) has a heat shrinkage factor at 160° C. of 5% or less.

(7) The fiber-containing product for hair according to any one of (1) to (6), wherein the polyester-based fiber (A) has a LOI value of 25 or greater.

(8) The fiber-containing product for hair according to any one of (1) to (7), wherein the polyester (C) is a polyester that further includes a phosphorus-based flame retardant (D) and/or a bromine-based flame retardant (E).

(9) The fiber-containing product for hair according to (8), wherein the phosphorus-based flame retardant (D) is at least one compound selected from the group consisting of a phosphate-based compound, a phosphonate-based compound, a phosphinate-based compound, a phosphine oxide-based compound, a phosphonite-based compound, a phosphinite-based compound, a phosphine-based compound, a condensed phosphoric acid ester compound, a phosphoric acid ester amide compound, and an organic cyclic phosphorus-based compound.

(10) The fiber-containing product for hair according to (8), wherein the bromine-based flame retardant (E) is at least one compound selected from the group consisting of a bromine-containing phosphoric acid ester-based flame retardant, a brominated polystyrene-based flame retardant, a brominated benzyl acrylate-based flame retardant, a brominated epoxy-based flame retardant, a brominated polycarbonate-based flame retardant, a tetrabromobisphenol A derivative, a bromine-containing triazine-based compound, and a bromine-containing isocyanuric acid-based compound.

(11) The fiber-containing product for hair according to any one of (1) to (10), wherein the polyester-based fiber (A) and/or the regenerated collagen fiber (B) further include an organic fine particle (F) and/or an inorganic fine particle (G).

(12) The fiber-containing product for hair according to (11), wherein the organic fine particle (F) is at least one selected from the group consisting of polyarylate, polyamide, fluorocarbon resin, silicone resin, cross-linked acrylic resin, and cross-linked polystyrene.

(13) The fiber-containing product for hair according to (11), wherein the inorganic fine particle (G) is at least one selected from the group consisting of calcium carbonate, silicon oxide, titanium oxide, aluminum oxide, zinc oxide, talc, kaoline, montmorillonite, bentonite, and mica.

(14) A head dressing product including the fiber-containing product for hair according to any one of (1) to (13).

(15) The head dressing product according to (14), wherein the head dressing product is a weave, wig, toupee, hair extension or hair accessory.

### Effects of the Invention

According to the present invention, it is possible to obtain fiber-containing product for hair that has the same texture and luster as those of human hair, excellent shape-retaining capability, such as curl-retaining capability, and flame retardancy although it is chemical fiber (artificial fiber). Specifically, the fiber-containing product for hair of the present invention has a soft texture and a natural luster that human hair has. At the same time, in the fiber-containing product for hair of the present invention, disadvantages, such as disappearance of curl after absorption of water, increased curl diameter, and stretch-out of curl after shampooing, are improved. Further, the fiber-containing product for hair of the present invention has flame retardancy and heat resistance.

Furthermore, the fiber-containing product for hair of the present invention can be curled without the need to cool the hair when hair-ironed.

Human hair varies in thickness, hardness, length and the like among different individuals and different races, and thus it is difficult to obtain human hair with a stable quality. Because the fiber-containing product for hair of the present invention employs regenerated collagen fiber, the present invention can provide fiber having a stable quality.

The reason why the fiber-containing product for hair of the present invention has flame retardancy is presumably because the regenerated collagen fiber having an aluminum compound has flame retardancy. It is not easy to expect that the fiber that includes flammable polyester fiber and regenerated collagen fiber containing an aluminum compound has flame retardancy and is usable as artificial hair.

### BEST MODE FOR CARRYING OUT THE INVENTION

It is preferable that the polyester fiber (A) that is used for the fiber-containing product for hair of the present invention is a fiber formed from at least one polyester (C) selected from the group consisting of polyalkylene terephthalate, copolymerized polyester that contains polyalkylene terephthalate as the main component, and a polymer alloy that contains polyester as the main component.

Examples of the polyester (C) include: polyalkylene terephthalate such as polyethylene terephthalate, polypropylene terephthalate, and polybutylene terephthalate; copolymerized polyester that contains polyalkylene terephthalate described above as the main component and a small amount of a copolymerizable component; and a polymer alloy of polyalkylene terephthalate described above with polyethylene naphthalate, polyarylate or polycarbonate. As used herein, the “main component” means a component that accounts for 80 mol % or more.

Examples of the copolymerizable component include: polycarboxylic acids such as isophthalic acid, orthophthalic acid, naphthalene dicarboxylic acid, paraphenylene dicarboxylic acid, trimellitic acid, pyromellitic acid, succinic acid, glutaric acid, adipic acid, superic acid, azelaic acid, sebacic acid, and dodecanedioic acid, and derivatives thereof; dicarboxylic acids containing a sulfonic acid salt, such as 5-sodium sulfoisophthalate and dihydroxyethyl 5-sodium sulfoisophthalate, and derivatives thereof; 1,2-propanediol; 1,3-propanediol; 1,4-butanediol; 1,6-hexanediol; neopentyl glycol; 1,4-cyclohexanedimethanol; diethylene glycol; polyethylene glycol; trimethylolpropane; pentaerythritol; 4-hydroxybenzoic acid; and ε-caprolactone.

Typically, the copolymerized polyester is produced by causing a polymer of terephthalic acid and/or a derivative thereof (e.g., methyl terephthalate) and alkylene glycol, which is the main component, to react with a small amount of the copolymerizable component. This is preferable in terms of stability, and ease of operation. However, it is also possible to produce the copolymerized polyester by polymerizing a mixture of terephthalic acid and/or a derivative thereof (e.g., methyl terephthalate) and alkylene glycol serving as the main component with a still smaller amount of a monomer or oligomer component, which is a copolymerizable component.

There is no particular limitation on the copolymerization method as long as the copolymerizable component is polycondensed with the main chain and/or side chain of polyalkylene terephthalate, which is the main component, in the copolymerized polyester.

Specific examples of the copolymerized polyester containing polyalkylene terephthalate as the main component include: polyester that contains polyethylene terephthalate as the main component and is copolymerized with ethylene glycol ether of bisphenol A; polyester copolymerized with 1,4-cyclohexanedimethanol; and polyester copolymerized with dihydroxyethyl 5-sodium sulfoisophthalate.

Examples of the polymer alloy that contains polyalkylene terephthalate as the main component include a polymer alloy of polyethylene terephthalate and polyethylene naphthalate, a polymer alloy of polyethylene terephthalate and polyarylate, and a polymer alloy of polyethylene terephthalate and polycarbonate.

The polyalkylene terephthalates, the copolymerized polyesters thereof and the polymer alloys thereof may be used alone or in combination of two or more.

Among those listed, it is preferable to use polyethylene terephthalate, polypropylene terephthalate, polybutylene terephthalate, copolymerized polyesters (polyester that contains polyethylene terephthalate as the main component and is copolymerized with ethylene glycol ether of bisphenol A, polyester copolymerized with 1,4-cyclohexanedimethanol, polyester compolymerized with dihydroxyethyl 5-sodium sulfoisophthalate), a polymer alloy of polyethylene terephthalate and polyethylene naphthalate, a polymer alloy of polyethylene terephthalate and polyarylate, or a polymer alloy of polyethylene terephthalate and polycarbonate, in terms of heat resistance and fiber physical properties. A mixture of two or more of the above also is preferable.

The polyester (C) preferably has an intrinsic viscosity of 0.5 to 1.4, and more preferably 0.6 to 1.2. When the intrinsic viscosity of the polyester (C) is less than 0.5, the mechanical strength of the resulting fiber tends to be decreased. When the intrinsic viscosity exceeds 1.4, the melt viscosity increases with increasing molecular weight, so that melt spinning may become difficult, or the fineness tends to be non-uniform.

The polyester-based fiber (A) used for the fiber-containing product for hair of the present invention preferably has a single fiber fineness of 20 to 100 dtex, more preferably 30 to 90 dtex, and most preferably 40 to 80 dtex. When the single fiber fineness of the polyester-based fiber (A) is less than 20 dtex, the fiber will be too soft to use for hair, and the styling of the hair tends to be difficult. When the single fiber fineness exceeds 100 dtex, the fiber tends to be hard.

It is preferable that the polyester-based fiber (A) has a heat shrinkage factor at 180° C. of 5% or less, and more preferably 4% or less. When the heat shrinkage factor at 180° C. of the polyester-based fiber (A) exceeds 5%, the fiber may contract or become crinkled in the process of steam setting at 100° C. or higher, or hair-ironing at 160° C. or higher.

As used herein, the heat shrinkage factor is obtained by measuring a heat shrinkage factor at room temperature to around the melting point with the application of a load of 10 mg/dtex or less at a rate of temperature increase of 2 to 20° C./min using a thermomechanical analysis apparatus typically used for thermoanalysis. However, the value varies according to the load and the rate of temperature increase. In the present invention, a heat shrinkage factor is measured at each temperature with a load of 5.55 mg/dtex and a rate of temperature increase of 3° C./min, and the heat shrinkage factor at 180° C. is employed as the heat shrinkage factor of the polyester-based fiber (A).

Although the regenerated collagen fiber (B) of the present invention is flame retardant, a flame-retardant polyester fiber may be used as the polyester-based fiber (A). In this case, the fiber-containing product for hair of the present invention can have further improved flame retardancy. Also, when the mixing ratio of the regenerated collagen fiber (B) is low, or the like, in order to obtain sufficient flame retardancy, it is desirable to use a flame-retardant polyester fiber as the polyester-based fiber (A).

When using a flame-retardant polyester fiber, it is preferable that the flame-retardant polyester fiber has a LOI value of 25 or greater, more preferably 26 or greater, and even more preferably 27 or greater. When the LOI value of the polyester-based fiber (A) is less than 25, the fiber burns easily, and melt-dropping (dripping) may occur during combustion, which may cause burn injury.

As the flame-retardant polyester-based fiber (A), for example, a fiber formed from a composition obtained by melting and kneading the polyester (C) as typified by polyethylene terephthalate with a phosphorus-based flame retardant (D) and/or a bromine-based flame retardant (E), a fiber formed from polyester obtained by copolymerizing polyester with a reactive type phosphorus-based flame retardant, or the like can be used. Among them, it is preferable to use a fiber formed from a composition obtained by melting and kneading the polyester (C) with a phosphorus-based flame retardant (D) and/or a bromine-based flame retardant (E) from the viewpoint of small impact on fiber physical properties and quality, the persistence of flame retardancy, and cost.

There is no particular limitation on the phosphorus-based flame retardant (D), and a commonly-used phosphorus-containing flame retardant can be used. Examples thereof include a phosphate-based compound, a phosphonate-based compound, a phosphinate-based compound, a phosphine oxide-based compound, a phosphonite-based compound, a phosphinite-based compound, a phosphine-based compound, a condensed phosphoric acid ester-based compound, a phosphoric acid ester amide compound, and an organic cyclic phosphorus-based compound. They may be used alone or in combination of two or more.

Specific examples of the phosphorus-based flame retardant (D) include trimethyl phosphate, triethyl phosphate, tributyl phosphate, tri(2-ethylhexyl)phosphate, triphenyl phosphate, tricresyl phosphate, trixylenyl phosphate, tris(isopropylphenyl)phosphate, tris(phenylphenyl)phosphate, trineftyl phosphate, cresyl phenyl phosphate, xylenyl diphenyl phosphate, triphenylphosphine oxide, tricresylphosphine oxide, diphenyl methanephosphonate, diethyl phenylphosphonate, as well as resorcinol polyphenyl phosphate, resorcinol poly(di-2,6-xylyl)phosphate, bisphenol A polycresyl phosphate, and hydroquinone poly(2,6-xylyl)phosphate.

As the condensed phosphoric acid ester-based compound, the phosphoric acid ester amide compound, or the organic cyclic phosphorus-based compound, for example, a condensed phosphoric acid ester-based compound represented by the following general formula (1), a phosphoric acid ester amide compound represented by the following general formula (2), and an organic cyclic phosphorus-based compound represented by the following general formula (3) can be used.

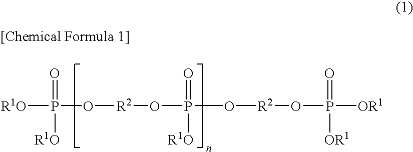

where R¹ represents a monovalent aromatic hydrocarbon group or aliphatic hydrocarbon group, and they may each be the same or different; R² represents a divalent aromatic hydrocarbon group, and when two or more R² are included, they may each be the same or different; and n represents 0 to 15.

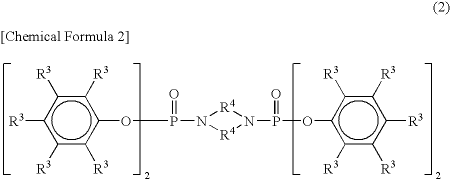

where R³ represents a hydrogen atom, or a straight or branched alkyl group, and they may each be the same or different; R⁴ represents a divalent straight or branched alkylene group, a straight or branched hydroxyalkylene group, a cycloalkylene group, an alkylene group containing ether oxygen in the main chain, a substituted or unsubstituted arylene group, or a substituted or unsubstituted aralkyl group, and they may each be the same or different.

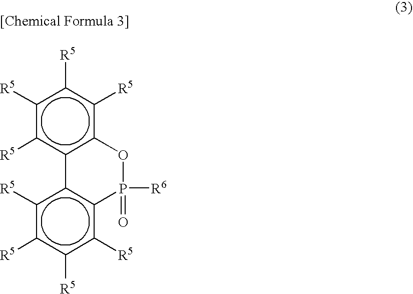

where R⁵ represents a hydrogen atom, or a straight or branched alkyl group, and they may each be the same or different; R⁶ represents a hydrogen atom, or a straight or branched alkyl group, a straight or branched hydroxyalkyl group, a cycloalkyl group, a substituted or unsubstituted aryl group, a substituted or unsubstituted aralkyl group, or a substituted or unsubstituted alkoxy group.

As specific examples thereof, condensed phosphoric acid ester-based compounds represented by the general formula (1) such as:

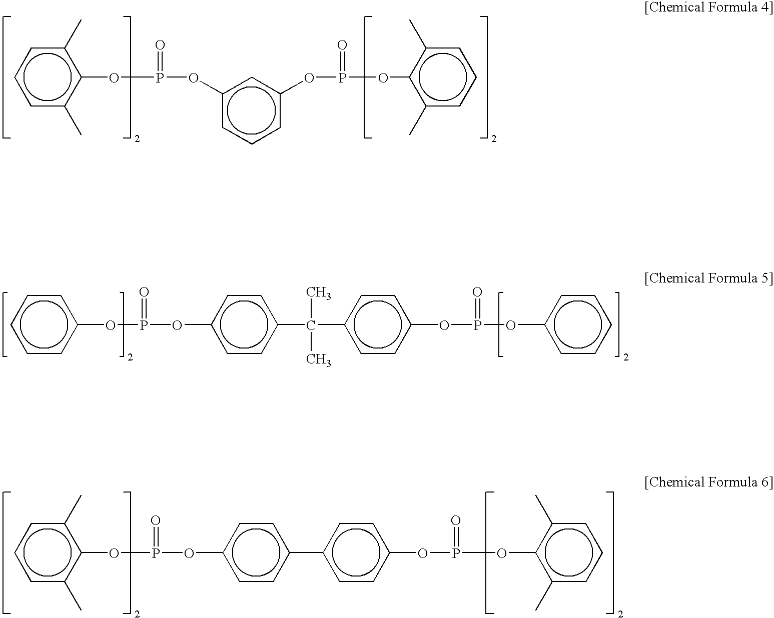

phosphoric acid ester amide compounds represented by the general formula (2) such as:

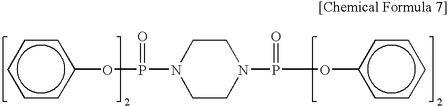

organic cyclic phosphorus-based compounds represented by the general formula (3) such as:

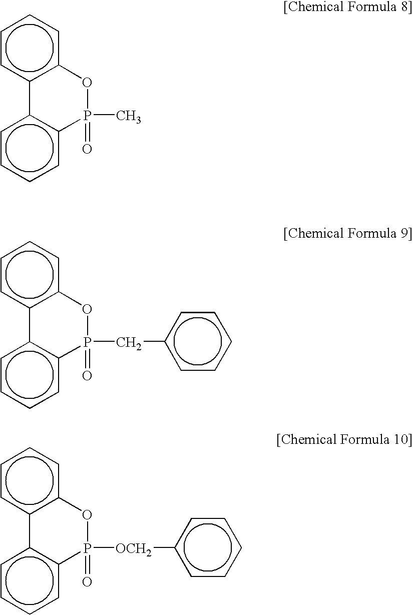

and the like can be used.

There is no particular limitation on the bromine-based flame retardant (E), a commonly-used bromine-containing flame retardant can be used. Examples thereof include bromine-containing phosphoric acid esters, brominated polystyrenes, brominated polybenzyl acrylates, brominated epoxy oligomers, brominated polycarbonate oligomers, tetrabromobisphenol A derivatives, bromine-containing triazine-based compounds, and bromine-containing isocyanuric acid-based compounds. They may be used alone or in combination of two or more.

Specific examples of the bromine-based flame retardant (E) of the present invention include: bromine-containing phosphoric acid esters such as pentabromo toluene, hexabromo benzene, decabromodiphenyl, decabromodiphenyl ether, bis(tribromophenoxy)ethane, tetrabromophthalic anhydride, ethylene bis(tetrabromophthalimide), ethylene bis(pentabromophenyl), octabromotrimethylphenyl indan, and tris(tribromoneopentyl)phosphate;

brominated polystyrenes such as

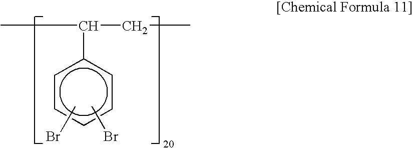

brominated polybenzyl acrylates such as

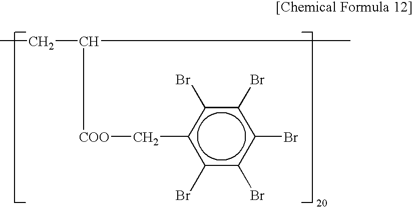

brominated epoxy oligomers such as

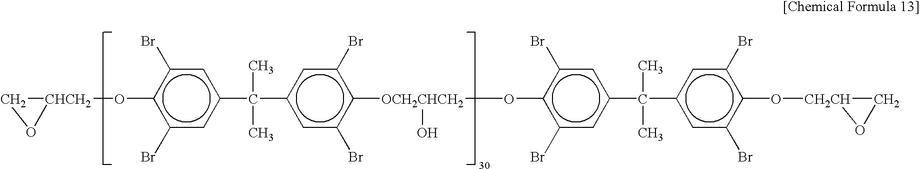

brominated polycarbonate oligomers such as

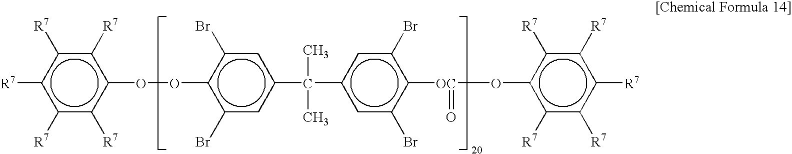

where R⁷ represents a hydrogen or bromine atom, and they each may be the same or different;

tetrabromobisphenol A; tetrabromobisphenol A derivatives such as tetrabromobisphenol A-bis(2,3-dibromopropylether), tetrabromobisphenol A-bis(allylether), and tetrabromobisphenol A-bis(hydroxyethylether); bromine-containing triazine-based compounds such as tris(tribromophenoxy)triazine; and bromine-containing isocyanuric acid-based compounds such as tris(2,3-dibromopropyl)isocyanurate.

Among the phosphorus-based flame retardants (D) and the bromine-based flame retardants (E) listed above, bromine-containing phosphoric acid ester-based flame retardants, brominated polystyrene-based flame retardants, brominated benzyl acrylate-based flame retardants, brominated epoxy-based flame retardants, brominated polycarbonate-based flame retardants, tetrabromobisphenol A derivatives, bromine-containing triazine-based compounds, and bromine-containing isocyanuric acid-based compounds are preferable because the reduction in heat resistance and fiber physical properties is small, and sufficient flame retardancy is obtained.

It is preferable that the amount of the phosphorus-based flame retardant (D) and/or bromine-based flame retardant (E) to be used is 5 to 30 parts by weight, more preferably 6 to 25 parts by weight, and even more preferably 7 to 20 parts by weight relative to 100 parts by weight of the polyester (C). When the amount of the phosphorus-based flame retardant (D) and/or bromine-based flame retardant (E) to be used is less than 3 parts by weight, it may be difficult to obtain the flame retardant effect. When the amount is greater than 30 parts by weight, the mechanical property, heat resistance and resistance to dripping may be impaired.

Flame retardancy can be exhibited by mixing the phosphorus-based flame retardant (D) and/or the bromine-based flame retardant (E), but the flame retardant effect can be improved significantly by mixing a flame retardant aid, and sufficient flame retardancy can be obtained. There is no particular limitation on the flame retardant aid used in the present invention, and a commonly-used flame retardant aid can be used.

Specific examples of the flame retardant aid include melamine cyanurate, antimony trioxide, antimony tetroxide, antimony pentoxide, and sodium antimonite. They may be used alone or in combination of two or more. From the viewpoint of spinning processability of the mixture, sodium antimonite is preferable.

As the flame retardant aid used in the present invention, those having an average particle size of 15 μm or less can be used. If particles having an average particle size of 0.3 to 1.0 μm are used as the flame retardant aid, the covering rate becomes the largest, and the color tone (color developing property) of the artificial hair may be decreased. In this case, it is preferable to reduce the amount to be used, or use those having an average particle size of 1.5 to 15 μm, more preferably 1.7 to 12 μm, and even more preferably 1.9 to 10 μm.

The amount of the flame retardant aid to be used preferably is 10 parts by weight or less, more preferably 8 parts by weight or less, and even more preferably 6 parts by weight or less relative to 100 parts by weight of the polyester (C). Flame retardancy can be exhibited even when the amount of the flame retardant aid to be used is 0 parts by weight, but it is preferable to use 0.5 parts by weight or more to obtain still higher flame retardancy. When the amount of the flame retardant aid to be used is greater than 10 parts by weight, process stability, outer appearance and transparency may be impaired.

The polyester-based composition from which the polyester-based fiber (A) is produced can be produced by, for example, dry blending the polyester (C) with the phosphorus-based flame retardant (D) and/or the bromine-based flame retardant (E) as necessary, and an organic fine particle (F) component and/or an inorganic fine particle (G), which will be described later, in advance, and melting and kneading them using various commonly-used kneaders.

Examples of the kneader include a single screw extruder, a twin screw extruder, a roll, a banbury mixer and a kneader. Among them, a twin screw extruder is preferable in terms of ease of adjusting the degree of kneading and ease of operation.

The polyester-based composition can be obtained by, for example, melting and kneading the above components using a twin screw extruder having a screw diameter of 45 mm with a cylinder temperature set to 260 to 300° C., a discharging amount of 50 to 150 kg/hr, and a screw speed of 150 to 200 rpm, by pulling strands through the die, followed by water cooling, and by forming the strands into pellets using a strand cutter.

The polyester-based fiber (A) of the present invention can be produced by melt spinning the polyester-based composition by a conventional melt spinning method.

Specifically, for example, the polyester-based composition is melt spun with the temperatures of the extruder, the gear pump and the die set to 250 to 310° C., the spun filament yarns are passed through a heat tube, cooled to a temperature not greater than the glass transition temperature, and pulled at a rate of 50 to 5,000 m/min to obtain spun filaments. It is also possible to control the fineness by cooling the spun filament yarns in a water bath filled with water for cooling. The temperature and length of the heat tube, the temperature and flowing amount of cooling air, the temperature of the water bath for cooling, the cooling time, and the pulling speed can be adjusted to appropriate values by the discharging amount and the number of dies.

The obtained undrawn filaments are hot drawn, but the drawing may be performed by either of a two-step method in which undrawn filaments are first wound up and then drawn, or a direct spin-drawing method in which undrawn filaments are drawn continuously without being wound up. The hot drawing is performed by a multi-stage drawing method such as a single-stage drawing method or a two or more stage drawing method. As the heating means used in the hot drawing, a heat roller, heat plate, steam jet apparatus, hot-water bath, or the like can be used. They may be used in combination where appropriate.

Where necessary, various additives may be added to the polyester-based fiber (A) such as a heat resistant, a light stabilizer, a fluorescent agent, an antioxidant, an antistatic agent, a pigment, a plasticizer, and a lubricant. By adding a pigment, spun-dyed fibers can be obtained.

When the polyester-based fiber (A) is spun-dyed, it can be used as it is. When the polyester-based fiber (A) is not spun-dyed, the polyester-based fiber (A) can be dyed under the same conditions as regular polyester-based fibers. As the pigment, colorant and aid used in dyeing, it is preferable to use those having good weather resistance and good flame retardancy.

The regenerated collagen fiber (B) used in the present invention is a regenerated collagen fiber containing an aluminum compound in the fiber. As the aluminum compound, an aluminum salt is preferable. As the aluminum salt, an aluminum salt used for leather tanning as disclosed in WO 2001-000920 or U.S. Pat. No. 6,749,642 is preferable. By using an aluminum salt for tanning, a regenerated collagen fiber having no color and excellent water resistance can be obtained.

The amount of the aluminum compound in the regenerated collagen fiber preferably is 8 to 20 wt % on an aluminum oxide basis because the flame retardancy can be improved sufficiently. When the content of the aluminum compound in the regenerated collagen fiber is less than 8 wt %, the flame retardancy and water resistance tend to be insufficient for practical use. Conversely, when the content exceeds 20 wt %, the flame retardancy and water resistance are good, but the fiber tends to be hard and the texture of collagen fibers may be impaired.

In order to cause the regenerated collagen fiber to contain a large amount of aluminum salt, it is preferable that the regenerated collagen fiber is sufficiently swollen with water in advance. The regenerated collagen fiber having been sufficiently swollen with water then is immersed in an aqueous solution of aluminum salt, whereby the aluminum salt permeates sufficiently, and the content of the aluminum salt in the fiber can be increased.

The aluminum salt used here preferably is, but not particularly limited thereto, a basic aluminum salt that is highly reactive with collagen. Further, it is more preferable to use basic aluminum chloride or basic aluminum sulfate represented by the following formulas.

Al(OH)ₙCl₃₋ₙ or Al₂(OH)₂ₙ(SO₄)₃₋ₙ [Chemical Formula 15

where n is 0.5 to 2.5.

In the present invention, as the raw material for the regenerated collagen fiber, for example, fresh rawhide obtained from slaughtered animals such as cows or split hide obtained from salted rawhide is used. The split hide and the like, for the most part, are made of insoluble collagen fiber, and thus the flesh part attached in a reticulated pattern or the salt component used to prevent spoilage and deterioration is removed before use.

In the insoluble collagen fiber, impurities such as proteins other than collagen such as lipids including glyceride, phospholipid and free fatty acid, glycoprotein, and albumin are present. Because these impurities significantly affect the spinning stability during fibrillation, the quality such as shine and tenacity, the odor, and the like, it is desirable to remove these impurities in advance by, for example, hydrolyzing the fat component of the insoluble collagen fiber by liming so as to untangle the collagen fibers, followed by a conventional leather treatment such as an acid, alkaline treatment, an enzyme treatment or a solvent treatment.

The insoluble collagen having undergone the above treatment is then subjected to a solubilization process to cleave the cross-linked peptide portions of the insoluble collagen. As the method for such a solubilization process, any known and commonly used alkaline solubilization method, enzyme solubilization method, or the like can be used.

In the case of employing the alkaline solubilization method, it is preferable to perform, for example, neutralization with acid such as hydrochloric acid. As a method improved over a conventionally-known alkaline solubilization method, a method as described in JP 46(1971)-15088 B may be employed. The enzyme solubilization method is advantageous in that regenerated collagen having a uniform molecular weight can be obtained, and thus is preferable to use in the present invention. As the enzyme solubilization method, for example, a method as described in JP 48(1973)-27518 B or the like can be employed. In the present invention, it is also possible to employ the alkaline solubilization method along with the enzyme solubilization method.

When the collagen solubilized in the manner as described above is subjected to a further treatment, such as pH adjustment, salting out, washing with water and solvent treatment, regenerated collagen fiber that is excellent in quality and the like can be obtained. Accordingly, it is preferable to perform the above treatment.

The obtained solubilized collagen is dissolved in an acid aqueous solution adjusted with hydrochloric acid, acetic acid, lactic acid or the like to a pH of 2 to 4.5 so as to have a predetermined concentration of, for example, about 1 to 15 wt %, and particularly about 2 to 10 wt %. The obtained collagen aqueous solution may be subjected to a degassing process under a reduced pressure and agitation, or filtration may be performed to remove water-insoluble components, where necessary.

Further, where necessary, the collagen aqueous solution obtained as described above may be mixed with an appropriate amount of additives such as a stabilizer and a water-soluble polymer compound for the purpose of improving mechanical strength, water resistance, heat resistance, shine property and spinning property, and preventing coloring and spoilage, and the like.

Subsequently, the collagen aqueous solution is, for example, discharged through a spinning nozzle, and immersed in an aqueous solution of inorganic salt to form regenerated collagen fiber. As the aqueous solution of inorganic salt, for example, an aqueous solution of a water-soluble inorganic salt such as sodium sulfate, sodium chloride and ammonium sulfate is used. The concentration of the inorganic salt usually is adjusted to 10 to 40 wt %. It is to be understood that the type of aqueous solution and the concentration are not limited to those described above.

It is desirable that the aqueous solution of inorganic salt is mixed with a metal salt such as sodium borate or sodium acetate, or hydrochloric acid, acetic acid, sodium hydroxide, or the like, so as to adjust the pH of the aqueous solution of inorganic salt to usually 2 to 13, and preferably 4 to 12. When the pH is less than 2 or over 13, the peptide bond of the collagen is easily hydrolyzed, and thus it may be difficult to obtain the intended fiber. Also, although there is no particular limitation on the temperature of the aqueous solution of inorganic salt, it is preferable that the temperature is usually 35° C. or lower. When the temperature is higher than 35° C., the soluble collagen may be denatured, or the strength of spun fiber may be decreased, making it difficult to produce stable filament. There is no particular limitation on the lower limit of the temperature, and usually, the temperature may be adjusted to an appropriate level according to the solubility of the inorganic salt.

Furthermore, in order to improve the fibrillation tendency of the fiber, an aldehyde compound such as formaldehyde, glutaraldehyde, glyoxal or dialdehyde starch may be added to the aqueous solution of inorganic salt. The addition of the aldehyde compound to the aqueous solution of inorganic salt is advantageous in that the addition causes a cross-linking reaction with the collagen, the fiber does not dissolve in water, and washing with water for removing the inorganic salt incorporated in the spinning process can be performed.

The thus obtained regenerated collagen fiber is swollen with water or the aqueous solution of inorganic salt. This swollen state preferably is a state in which water or the aqueous solution of inorganic salt is contained in a content 4 to 15 times greater than the weight of the regenerated collagen fiber. When the content of water or the aqueous solution of inorganic salt is less than 4 times, the content of aluminum salt in the regenerated collagen fiber will be small, and the water resistance tends to be insufficient. Conversely, when the content exceeds 15 times, the strength of the fiber will be weak, and the ease of handling tends to be difficult.

The swollen regenerated collagen fiber then is immersed in an aqueous solution of an aluminum salt. As the aluminum salt of the aluminum salt aqueous solution, it is preferable to use basic aluminum chloride or basic aluminum sulfate represented by the following formula:

Al(OH)ₙCl₃₋ₙ or Al₂(OH)₂ₙ(SO₄)₃₋ₙ [Chemical Formula 16

where n is 0.5 to 2.5. Specific examples of the aluminum salt include aluminum sulfate, aluminum chloride, and alum. These aluminums may be used alone or in combination of two or more.

It is preferable that the concentration of the aluminum salt in the aluminum salt aqueous solution is 0.3 to 5 wt % on an aluminum oxide basis. When the concentration of the aluminum salt is less than 0.3 wt %, the content of the aluminum salt in the regenerated collagen fiber will be small, and the water resistance tends to be insufficient. Conversely, when the content exceeds 5 wt %, the fiber after treatment becomes hard, and the texture tends to be impaired.

The pH of the aluminum salt aqueous solution is adjusted to usually 2.5 to 5 by, for example, using hydrochloric acid, sulfuric acid, acetic acid, sodium hydroxide, sodium carbonate, or the like. When the pH of the aluminum salt aqueous solution is less than 2.5, the structure of the collagen may be broken to denature the collagen. Conversely, when the pH exceeds 5, the aluminum salt precipitates and may hardly permeate the fiber. It is preferable that the pH of the aluminum salt aqueous solution is first adjusted to 2.2 to 3.5 to cause the aluminum salt aqueous solution to permeate the regenerated collagen fiber sufficiently, and after that, for example, sodium hydroxide, sodium carbonate or the like is added to adjust the pH to 3.5 to 5 to finish the treatment. However, when using a highly basic aluminum salt, only the first pH adjustment to 2.2 to 5 may be carried out.

The solution temperature of the aluminum salt aqueous solution preferably is, but not limited to, 50° C. or lower. When the solution temperature exceeds 50° C., the regenerated collagen fiber tends to be denatured.

The time for immersing the regenerated collagen fiber in the aluminum salt aqueous solution preferably is 3 hours or longer, and more preferably 6 to 25 hours. When the immersion time is less than 3 hours, the reaction of the aluminum salt hardly proceeds, and the water resistance of the regenerated collagen fiber tends to be insufficient. There is no particular limitation on the upper limit of the immersion time, but when the immersion time is within 25 hours, the reaction of the aluminum salt proceeds sufficiently, and the water resistance also is favorable.

In order to prevent concentration variation caused by rapid absorption of the aluminum salt into the regenerated collagen fiber, an inorganic salt such as sodium chloride, sodium sulfate or potassium chloride may be added to the aluminum salt aqueous solution where appropriate. The regenerated collagen fiber treated with the aluminum salt as described above then is subjected to washing with water, oiling, and drying. The regenerated collagen fiber thus obtained has no color, unlike those treated by a conventional method using chromium salt, and excellent water resistance.

The regenerated collagen fiber (B) used for the fiber-containing product for hair of the present invention preferably has a single fiber fineness of 30 to 90 dtex, more preferably 35 to 85 dtex, and even more preferably 40 to 80 dtex. When the single fiber fineness of the regenerated collagen fiber (B) is less than 30 dtex, the fiber will be too soft to use for hair, and styling tends to be difficult. When the single fiber fineness exceeds 90 dtex, the fiber tends to be hard.

The regenerated collagen fiber (B) preferably has a heat shrinkage factor at 160° C. of 5% or less, and more preferably 4% or less. When the heat shrinkage factor at 160° C. of the regenerated collagen fiber (B) exceeds 5%, the fiber may contract or become crinkled in the process of steam setting at 100° C. or higher, or hair-ironing at 160° C. or higher. The measurement of the heat shrinkage factor is performed under the same conditions as those measured for the polyester-based fiber (A), and the heat shrinkage factor at 160° C. is employed.

The polyester-based fiber (A) and/or the regenerated collagen fiber (B) of the present invention may be mixed with an organic fine particle (F) and/or an inorganic fine particle (G), whereby fine protrusions can be formed on the fiber surface, and the shine and luster of the fiber surface can be adjusted.

As the organic fine particle (F) used in the present invention, an organic resin component having a structure that is incompatible or partially incompatible with the polyester (C), the regenerated collagen fiber (B), or the phosphorus-based flame retardant (D) and/or the bromine-based flame retardant (E) can be used. Examples of the organic fine particle (F) include polyarylate, polyamide, fluorocarbon resin, silicone resin, cross-linked acrylic resin, and cross-linked polystyrene. They may be used alone or in combination of two or more.

As the inorganic fine particle (G) used in the present invention, considering the transparency of the fiber and the influence on color developing property, it is preferable to use those having a refractive index close to that of the polyester (C), the regenerated collagen fiber (B), or the phosphorus-based flame retardant (D) and/or the bromine-based flame retardant (E). Examples of the inorganic fine particle (G) include calcium carbonate, silicon oxide, titanium oxide, aluminum oxide, zinc oxide, talc, kaoline, montmorillonite, bentonite, and mica. They may be used alone or in combination of two or more.

The organic fine particle (F) and/or the inorganic fine particle (G) used in the present invention preferably have an average particle size of 0.1 to 15 μm, more preferably 0.2 to 10 μm, and even more preferably 0.5 to 8 μm. When the particle size is less than 0.1 μm, the effect of adjusting shine tends to be small. When the particle size is greater than 15 μm, the effect of adjusting shine tends to be small, or filament breakage tends to occur.

The amount of the organic fine particle (F) and/or the inorganic fine particle (G) to be used in the present invention preferably is, but not limited to, 0.1 to 5 parts by weight, more preferably 0.2 to 3 parts by weight, and even more preferably 0.3 to 2 parts by weight relative to 100 parts by weight of the polyester (A) or the regenerated collagen fiber (B). When the amount of the organic fine particle (F) and/or the inorganic fine particle (G) to be used is greater than 5 parts by weight, the outer appearance, color tone and color developing property tend to be impaired. When the amount is less than 0.1 parts by weight, the number of fine protrusions formed on the fiber surface is reduced, the shine adjustment of the fiber surface tends to be insufficient.

The fiber-containing product for hair of the present invention is a fiber obtained by mixing the above-mentioned polyester-based fiber (A) and the above-mentioned regenerated collagen fiber (B).

By mixing the polyester-based fiber (A) and the regenerated collagen fiber (B), it is possible to produce properties that cannot be exhibited by using the polyester-based fiber (A) alone or the regenerated collagen fiber (B) alone. For example, with the polyester-based fiber (A) alone, cooling is necessary when styling with an iron, whereas with the mixture of (A) and (B), a curl can be formed neatly without cooling. Further, with the regenerated collagen fiber (B) alone, the curl shape is deformed easily, such as the curl turns weak after absorbing water, the size of the curl increases, the curl is stretched out by shampooing, or the like, whereas with the mixture of (A) and (B), the deformation of the curl shape can be suppressed.

The mixing ratio of the polyester-based fiber (A) and the regenerated collagen fiber (B) of the present invention (100 parts by weight in total of (A) and (B)) is selected as appropriate according to the quality required by various styles of head dressing products into which the fiber for artificial hair is processed. The mixing ratio preferably is polyester-based fiber (A)/regenerated collagen fiber (B)=90 parts by weight/10 parts by weight to 10 parts by weight/90 parts by weight, more preferably, 88 parts by weight/12 parts by weight to 12 parts by weight/88 parts by weight, and even more preferably 85 parts by weight/15 parts by weight to 15 parts by weight/85 parts by weight.

When the mixing ratio of the polyester-based fiber (A) is less than 10 parts by weight, or the mixing ratio of the regenerated collagen fiber (B) exceeds 90 parts by weight, the curl retention capability tends to be decreased. Conversely, when the mixing ratio of the polyester-based fiber (A) exceeds 90 parts by weight, or the mixing ratio of the regenerated collagen fiber (B) is less than 10 parts by weight, the flame retardancy and natural texture like human hair may be impaired, and a feature such as eliminating the need to take a cooling time for fixing the style in the hair ironing process tends to be inhibited.

The fiber-containing product for hair of the present invention is excellent in curl settability using an aesthetic thermal appliance (hair iron) and also in curl-retaining capability. Further, when the fiber surface has irregularities, the surface is adequately delustered, and thus the fiber can be used as artificial hair. It is also possible to use an oil agent such as a fiber surface treating agent or softener to impart a texture and a touch, so that the fiber resembles human hair.

The fiber-containing product for hair of the present invention is suitable for being processed into head dressing products such as wigs, toupees, weaves, hair extensions, braids, hair accessories and hair for dolls. Because the fiber-containing product for hair of the present invention has an appearance and a texture close to that of human hair, and curling properties greater than that of human hair, it is suitable particularly for being processed into a weave, wig, toupee, hair extension or hair accessory.

Wigs are dressing articles worn on the surface of the head by women and men primarily for fashion. They can be classified according to the covering area into partial wigs, half wigs, three quarter wigs, and full wigs.

Meanwhile, hair accessories refer to dressing articles other than wigs that are attached onto the existing hair or scalp. Examples thereof include: hair extensions, which are attached to the existing hair with a hair pin, hair clip or the like to make the existing hair long; and weaves (including those obtained by simply bundling fibers together, fibers commonly called “wefts” by a person skilled in the art that are obtained by processing fibers into a straw skirt-like shape, and dressing products formed from these processes by providing a curl shape), which are woven into braids along the scalp to combine with the existing hair, or attached to the scalp or the existing hair mainly in the form of straps with an adhesive or the like.

When processing the fiber-containing product for hair of the present invention into these head dressing products, known production methods can be used. For example, a wig can be produced by sewing the fibers with a sewing machine for wigs to make wefts, winding them onto a pipe, followed by steam setting to provide a curl, sewing the curled wefts onto a hair cap, and styling the hair.

### EXAMPLES

Hereinafter, the present invention will be described in further detail with reference to examples. However, the present invention is not limited thereto. The evaluation methods used in the examples are as follows. Unless otherwise specified, the heat shrinkage property and LOI value described below are to evaluate the polyester-based fiber (A) or the regenerated collagen fiber (B), and the flame retardancy, need to cool in hair. ironing process, steam setting, texture and the like are to evaluate the fiber bundles produced in the examples and comparative examples.

(Heat Shrinkage Property)

The heat shrinkage factor of the filaments was measured by using SSC5200H thermoanalysis TMA/SS150C available from Seiko Instruments Inc. Ten filaments having a length of 10 mm were taken, and a thermal shrinkage factor was measured at each temperature in the range of 30 to 280° C. with the application of a load of 5.55 mg/dtex and a rate of temperature increase of 3° C./min. As for the polyester-based fiber, the heat shrinkage factor at 180° C. was employed, and for the regenerated collagen fiber, the heat shrinkage factor at 160° C. was employed.

(Limiting Oxygen Index, LOI Value)

Sixteen cm long filaments were weighed to 0.25 g, the end was lightly fixed with double-sided tape, and the other end was held by a twining device to twine the filaments. After being sufficiently twined, the sample was folded at the center into two, and they were twined together. The end of the sample was fixed with Sellotape (registered trademark) such that the total length would be 7 cm. The sample was pre-dried at 105° C. for 60 minutes, and further dried in a desiccator for 30 minutes or longer. The dried sample was placed in a combustion tester with the bottom of the sample fixed, and the combustion tester was adjusted to a predetermined oxygen concentration. Forty seconds later, the top of the sample was ignited using a lighter adjusted to a 8 to 12 mm flame. The lighter was removed after ignition. The oxygen concentration with which the sample was burned 5 cm or more or burned for 3 minutes or longer was measured. The test was repeated three times under the same conditions to obtain a limiting oxygen index (LOI value). The greater the LOI value, the more difficult the sample is to burn and thus is highly flame retardant.

(Flame Retardancy)

Filaments having a fineness of about 50 dtex were cut into a length of 150 mm, and 0.7 g thereof was bundled, and the bundle was fixed to a stand with one end held by the clamp so that the bundle would hang vertically. A 20 mm flame was brought into contact with the fixed filaments having an effective length of 120 mm for 3 seconds. The combustion time after the flame was removed was measured to evaluate flame retardancy.

Double circle: the combustion time was less than 1 second.

Circle: 1 to less than 5 seconds.

Triangle: 5 to less than 8 seconds

Cross: 8 seconds or longer.

(Iron Settability)

Iron settability is an index that indicates the ease of curling using a hair iron, and the retaining capability of the curl shape. Filaments were lightly sandwiched by a hair iron heated to 180° C., and preheated by stroking them three times. The filaments at this time were visually inspected to evaluate the adhesion between filaments, the ease of combing, the contraction of filaments, and the breakage. Subsequently, the pre-heated filaments were wound around a hair iron and held for 10 seconds, then the iron was removed from the filaments. Visual inspection was performed to evaluate the ease of removal (rod out property) at this time and the curl-retaining capability after the removal.

(Need for Cooling in Hair Ironing Process)

Fibers having a length of 45 cm and a total fineness of about 150,000 dtex were folded into two, and they were bundled by tying one end with a thread to obtain a sample. The obtained fibers were fixed to a dummy head for testing such that the fibers hung from the dummy head. The ends of the hair bundle were wound with a hair iron heated at 180° C. for 10 seconds, and then the hair iron was removed to provide a curl to the sample. It was judged that for the sample whose curl was retained, a cooling process would be unnecessary, and for the sample whose curl was stretched out at this time, a cooling process would be necessary.

(Steam Settability)

Fibers having a length of 30 cm and a total fineness of 50,000 dtex were wound spirally around an aluminum pipe having a diameter of 25 mmφ and fixed with a rubber band. After that, this was inserted into a high pressure sterilizer (available from Hirayama Manufacturing Corporation) and the sterilizer was hermetically sealed. The temperature was increased to 120° C. by generating steam, and after having reached 120° C., the temperature was held for one hour. After being cooled, the fibers were detached from the pipe, and immersed in water for 5 minutes to allow the fibers to absorb water. The water on the surface was removed with filter paper, and the curled fibers were allowed to hang by fixing one end of the fibers. As the settability, the length immediately after hanging was measured (the initial length having no curl before providing a curl was 25 cm). As shampoo durability, the fibers were dried while being hung, and again immersed in water for water absorption. This was repeated three times, and the length was measured. In each measurement, a greater measured value indicates that the curl was stretched out. A measured value of 25 cm indicates that the curl was loosened and the fibers were straightened. As the curl diameter, the inner diameter of the curled fiber immediately after the water absorption after proving the curl described above.

(Texture)

Sensory evaluation was performed with trained hairdressers on a three point scale.

Circle: Very soft touch similar to that of human hair.

Triangle: Slightly harder touch than human hair.

Cross: Harder touch than human hair.

(Aesthetic Properties)

Fibers were formed into wefts, and they were wound around a pipe having a diameter of 60 mmφ, followed by steam setting at 120° C. to provide a curl. The curled wefts were sewn onto a hair cap to produce a short bob style wig. Evaluation was made by trained hairdressers in terms of curl-retaining capability of hair end, curl stability, straight property of middle part, style adaptability, texture of product, and ease of combing. The curl-retaining capability of hair end was evaluated by whether the curl necessary for the style was applied to hair end and its shape was retained, and whether the shape was retained even after sufficient absorption of water with a sprayer and drying. The curl stability was evaluated by whether the style was retained when the product was shaken in a practical range. The straight property of middle part was evaluated in terms of whether the appearance of curl in the middle part that was unnecessary for the style was suppressed. The texture of product was evaluated by whether the fiber had a bounciness close to that of human hair (not too hard or soft), and whether unnatural roughness was found. The ease of combing was evaluated by whether combing was smooth.

### Production Examples 1 to 6

Compositions having formulation ratios shown Table 1 were dried to a water content of 100 ppm or less, dry-blended and supplied to a twin screw extruder (TEX44, available from Japan Steel Works, Ltd.). They were melt-kneaded at a barrel temperature set to 280° C., formed into pellets, and dried to a water content of 100 ppm or less. Subsequently, the melt polymer was discharged using a melt-spinning machine (SV30, available from Shinko Machinery Co. Ltd.) at a barrel temperature set to 280° C. through the spinning die that had a nozzle aperture having a cocoon-shaped cross section with an aspect ratio of 1.4:1, cooled by cooling air of 20° C., and wound at a rate of 100 m/min to obtain undrawn filament. The obtained undrawn filament was drawn to 4 times using a heat roll heated to 85° C., heat-treated using a heat roll heated to 200° C., and wound at a rate of 30 m/min to obtain polyester-based fiber (multifilament) having a single fiber fineness of around 50 dtex. The obtained polyester-based fiber (tow filament) was immersed in an aqueous solution prepared such that KWC-Q (random copolymer polyether of ethy oxide-propylene oxide, available from Marubishi Oil Chemical Co., Ltd.)/KWC-B (amino-modified silicone, available from Marubishi Oil Chemical Co., Ltd.)/processing agent No. 29 (cationic surfactant, available from Marubishi Oil Chemical Co., Ltd.), which were hydrophilic fiber treating agents=0.08/0.12/0.06% omf, and then dried at 120° C. for 10 minutes using a hot air drier.

TABLE 1

| | | Production Example | | | | | |
|---|---|---|---|---|---|---|---|
| | | 1 | 2 | 3 | 4 | 5 | 6 |
| (C) | Polyethylene | 100 | 100 | 100 | 100 | 100 | 60 |
| | terephthalate*¹ | | | | | | |
| | Polybutylene | | | | | | 40 |
| | terephthalate*² | | | | | | |
| (D) | Phosphorus-based flame | | 12 | | | | |
| | retardant A*³ | | | | | | |
| | Phosphorus-based flame | | | 12 | | | |
| | retardant B*⁴ | | | | | | |
| (E) | Bromine-based flame | | | | 18 | 12 | 18 |
| | retardant*⁵ | | | | | | |
| (G) | Silica*⁶ | 2.0 | 1.5 | 1 | 1 | 0.5 | |
| | Sodium antimonite*⁷ | | | | 2 | | |

| | | | | | | |
|---|---|---|---|---|---|---|
| Single fiber finess (dtex) | 58 | 61 | 62 | 63 | 60 | 65 |
| LOI value | 20 | 25 | 26 | 29 | 26 | 27 |
| Heat shrinkage at 180° C. (%) | 3 | 4 | 3 | 3 | 3 | 7 |

*¹NOVAPEX BK-2180, available from Mitsubishi Chemical Corporation
*²KP-210, available from Kolon Industries, Inc.
*³PX-200, available from Daihachi Chemical Industry Co., Ltd.
*⁴SANKO BCA, available from Sanko Co. Ltd.

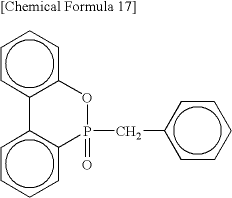

*⁵SR-T20000, available from Sakamoto Yakuhin Kogyo Co., Ltd.
*⁶SA-A, available from Nihon Seiko Co., Ltd.
*⁷NIPGEL AZ-200, available from Tosoh Silica Corporation

The results of the evaluation of the polyester-based fibers obtained in Production Examples 1 to 6 in terms of single fiber fineness, LOI, and heat shrinkage factor at 180° C. are shown in Table 1.

### Production Example 7

Cow split hide as a raw material was solubilized with alkali, and dissolved in an aqueous solution of lactic acid. The raw material solution adjusted to a pH of 3.2 and a collagen concentration of 6.2 wt % was degassed under a reduced pressure and agitation, and transferred to a piston type spinning raw material solution tank. Further, the raw material solution was allowed to stand under a reduced pressure for degassing. This raw material solution was pushed out by the piston, a predetermined amount thereof was transferred by a gear pump, and was filtered through a sintered filter having a pore size of 10 μm. The filtrate was passed through a spinning nozzle having 50 pores with a pore size of 0.3 mm and a pore length of 0.5 mm, and discharged into a coagulation bath of 25° C. containing 20 wt % of sodium sulfate and having a pH adjusted by boric acid and sodium hydroxide to 10. Subsequently, the resultant was introduced into a coagulation bath of 25° C. containing 15 wt % of sodium sulfate and 0.5 wt % of formaldehyde and having a pH adjusted by boric acid and sodium hydroxide to 9, immersed for one minute to such a degree that it was not dissolved in water to react formaldehyde, and washed with water at 25° C. The degree of swelling of the regenerated collagen fiber was measured after water-washing, and found to be 7.8 times.

Subsequently, the fiber swollen with water was immersed in an aqueous solution containing 10 wt % of basic aluminum chloride (basicity: 50%, aluminum content on aluminum oxide basis: 28 wt %) and 15 wt % of sodium chloride at 25° C. for 12 hours. After that, the obtained fiber was washed with hot water of 40° C. Then, the obtained regenerated collagen fiber (tow filament) was immersed in an aqueous solution prepared such that KWC-Q (random copolymer polyether of ethy oxide-propylene oxide, available from Marubishi Oil Chemical Co., Ltd.)/KWC-B (amino-modified silicone, available from Marubishi Oil Chemical Co., Ltd.), which were hydrophilic fiber treating agents=0.12/0.12% omf, and then dried under tension at 60° C. for 20 minutes using a hot air drier to obtain filaments having a single fiber fineness of 57 dtex. The obtained regenerated collagen fiber had a heat shrinkage factor at 160° C. of 4%. The aluminum salt content was 14 wt % on an aluminum oxide basis.

### Examples 1 to 15

The polyester-based fibers of Production Examples 1 to 6 and the regenerated collagen fiber of Production Example 7 were mixed at a ratio shown in Table 2, followed by hackling to straighten the filament yarn.

TABLE 2

| | | Example | | | | | | | | | | |
|---|---|---|---|---|---|---|---|---|---|---|---|---|
| | | 1 | 2 | 3 | 4 | 5 | 6 | 7 | 8 | 9 | 10 | 11 |
| (A) | Production Ex. 1 | 15 | 30 | | | | | | | | | |
| | Production Ex. 2 | | | 15 | | 70 | 60 | 30 | | | | |
| | Production Ex. 3 | | | | | | | | 70 | 50 | | |
| | Production Ex. 4 | | | | | | | | | | 60 | 40 |
| | Production Ex. 5 | | | | | | | | | | | |
| | Production Ex. 6 | | | | 70 | | | | | | | |
| (B) | Production Ex. 7 | 85 | 70 | 85 | 30 | 30 | 40 | 70 | 30 | 50 | 40 | 60 |
| | Human hair | | | | | | | | | | | |
| Flame retardancy | | ◯ | ◯ | ⊚ | ⊚ | ◯ | ◯ | ⊚ | ◯ | ⊚ | ◯ | ⊚ |
| Steam- | Settability | 14.5 | 13.5 | 14.5 | 12.0 | 13.5 | 13.0 | 15.0 | 12.0 | 13.5 | 11.0 | 11.5 |
| settability | Curl diameter | 2.5 | 2.4 | 2.5 | 2.3 | 2.5 | 2.5 | 2.6 | 2.3 | 2.5 | 2.5 | 2.7 |
| (120° C.) | Shampoo | 15.5 | 14.5 | 15.5 | 13.0 | 14.5 | 14.0 | 16.0 | 13.0 | 15.0 | 12.5 | 13.0 |
| Iron settability (160° C.) | | ◯ | ◯ | ◯ | ◯ | ◯ | ◯ | ◯ | ◯ | ◯ | ◯ | ◯ |
| Need to cool when hair-ironed | | No | No | No | No | No | No | No | No | No | No | No |
| Texture of tow | | ◯ | ◯ | ◯ | ◯ | ◯ | ◯ | ◯ | ◯ | ◯ | ◯ | ◯ |
| Aesthetic | Curl-retaining | ◯ | ◯ | ◯ | ⊚ | ⊚ | ◯ | ◯ | ⊚ | ◯ | ⊚ | ◯ |
| properties | capability of hair end | | | | | | | | | | | |
| | Curl stability | ◯ | ◯ | ◯ | ⊚ | ⊚ | ◯ | ◯ | ⊚ | ◯ | ⊚ | ◯ |
| | Straight property of | ◯ | ◯ | ◯ | ◯ | ◯ | ◯ | ◯ | ◯ | ◯ | ◯ | ◯ |
| | middle part | | | | | | | | | | | |
| | Style adaptability | ◯ | ◯ | ◯ | ◯ | ◯ | ◯ | ◯ | ◯ | ◯ | ⊚ | ◯ |
| | Texture of product | ◯ | ◯ | ◯ | ◯ | Δ | ⊚ | ⊚ | ◯ | ◯ | ⊚ | ⊚ |
| | Ease of combing | ⊚ | ⊚ | ⊚ | ⊚ | ⊚ | ⊚ | ⊚ | ⊚ | ⊚ | ⊚ | ⊚ |
| | | Example | | | | Comparative Example | | | | | | |
| | | 12 | 13 | 14 | 15 | 1 | 2 | 3 | 4 | 5 | 6 | 7 |
| (A) | Production Ex. 1 | | | | | 95 | 5 | | | 100 | | |
| | Production Ex. 2 | | | | | | | 60 | | | | |
| | Production Ex. 3 | | | | | | | | | | | |
| | Production Ex. 4 | 25 | | | | | | | 25 | | | |
| | Production Ex. 5 | | 75 | 60 | 45 | | | | | | | |
| | Production Ex. 6 | | | | | | | | | | | |
| (B) | Production Ex. 7 | 75 | 25 | 40 | 55 | 5 | 95 | | | | 100 | |
| | Human hair | | | | | | | 40 | 75 | | | 100 |
| Flame retardancy | | ⊚ | ⊚ | ⊚ | ⊚ | X | ◯ | X | X | X | ⊚ | X |
| Steam- | Settability | 12.0 | 11.5 | 12.0 | 12.5 | 13.0 | 18.0 | 15.0 | 14.5 | 12.5 | 18.5 | 20.0 |
| settability | Curl diameter | 2.9 | 2.4 | 2.6 | 2.8 | 2.3 | 2.7 | 2.7 | 2.9 | 2.3 | 2.8 | 4.1 |
| (120° C.) | Shampoo | 14.0 | 12.5 | 14.0 | 14.5 | 14.0 | 18.5 | 17.5 | 18.5 | 13.5 | 19.0 | 22.5 |
| Iron settability (160° C.) | | ◯ | ◯ | ◯ | ◯ | ◯ | ◯ | ◯ | ◯ | ◯ | ◯ | Δ |
| Need to cool when hair-ironed | | No | No | No | No | Yes | No | No | No | Yes | No | No |
| Texture of tow | | ◯ | ◯ | ◯ | ◯ | Δ | ◯ | ◯ | ◯ | Δ | ◯ | ◯ |
| Aesthetic | Curl-retaining | ⊚ | ⊚ | ◯ | ◯ | ⊚ | X | ◯ | Δ | ⊚ | X | X |
| properties | capability of hair end | | | | | | | | | | | |
| | Curl stability | ◯ | ⊚ | ⊚ | ◯ | ⊚ | Δ | ◯ | Δ | ⊚ | Δ | Δ |
| | Straight property of | ⊚ | ◯ | ◯ | ⊚ | X | ⊚ | ◯ | ◯ | X | ⊚ | ⊚ |
| | middle part | | | | | | | | | | | |
| | Style adaptability | ◯ | ⊚ | ⊚ | ◯ | X | Δ | ◯ | ◯ | X | X | X |
| | Texture of product | ⊚ | ◯ | ◯ | ⊚ | Δ | ⊚ | ◯ | ⊚ | Δ | ⊚ | ⊚ |
| | Ease of combing | ⊚ | ⊚ | ⊚ | ⊚ | Δ | ⊚ | ⊚ | ⊚ | Δ | ⊚ | ⊚ |

Table 2 shows the results obtained by subjecting the fibers to the above-described evaluation methods to evaluate flame retardancy, steam settability (settability, curl diameter, shampoo durability), the need for cooling when hair ironed, and texture. Further, the fibers were formed into wefts, and were wound around a pipe having a diameter of 60 mm(p, followed by steam setting at 120° C. to provide a curl. The curled wefts were sewn onto a hair cap to produce a short bob style wig. The aesthetic properties were evaluated. The results are shown in Table 2.

### Comparative Examples 1 to 7

The polyester-based fiber of Production Example 1 or 2 and the regenerated collagen fiber of Production Example 7 were mixed at a ratio shown in Table 2, followed by hackling to straighten the filament yarn. In Comparative Examples 3 and 6, commercially available human hair having a single fiber fineness of 68 dtex was used. Table 2 shows the results obtained by subjecting this fiber to the above-described evaluation methods to evaluate flame retardancy, steam settability (settability, curl diameter, shampoo durability), the need for cooling when hair ironed, and texture. Furthermore, similar to the examples, a short bob style wig was produced, and the aesthetic properties were evaluated. The results are shown in Table 2.

As shown in Table 2, it can be seen that the flame retardancy, the steam settability (settability, curl diameter, shampoo durability), and the need for cooling when hair ironed were excellent in the examples as compared to those of the comparative examples. Also, in the examples, similar to human hair, the straight property of the middle part was good. The hair surface was smooth, the texture and the ease of combing were good, and unlike human hair, the curl shape was retained even after absorbing water. Accordingly, the curl stability and style adaptability were improved, and a beautiful style was obtained.

Therefore, the fiber-containing product for hair that contains the polyester-based fiber (A) and the regenerated collagen fiber (B) containing an aluminum compound has flame retardancy, heat resistance, a soft texture like human hair, and a natural luster. Furthermore, it is also clear that this fiber-containing product for hair is a fiber that has features such as capability of providing a curl without the need to cool in hair ironing process, and has improved the disadvantages such as a curl weakened after water absorption, a large curl diameter, the stretch-out of the curl after shampooing.

Accordingly, it is found that this fiber easily is applied to a large curled style, and a head dressing product having a more beautiful style can be obtained, and used as an unprecedentedly excellent head dressing product.

### INDUSTRIAL APPLICABILITY

The present invention relates to a fiber-containing product for hair in which 90 to 10 parts by weight of polyester-based fiber (A) and 10 to 90 parts by weight of regenerated collagen fiber (B) containing an aluminum compound are mixed, or a head dressing product formed from this fiber. The fiber-containing product for hair or head dressing product of the present invention has a human hair-like texture and luster, as well as excellent curl-retaining capability and flame retardancy. As described above, the present invention is useful for industrial applications such as head dressing products including wigs, toupees, weaves, hair extensions, braids, hair accessory and hair for dolls.

1. A fiber-containing product for hair comprising 90 to 10 parts by weight of polyester-based fiber (A) and 10 to 90 parts by weight of regenerated collagen fiber (B) that includes an aluminum compound, the total of the (A) and the (B) being 100 parts by weight.

2. The fiber-containing product for hair according to claim 1, wherein the polyester-based fiber (A) is a polyester-based fiber comprising at least one selected from the group consisting of polyalkylene terephthalate, copolymerized polyester that includes polyalkylene terephthalate as a main component, and a polymer alloy that includes polyester as a main component.

3. The fiber-containing product for hair according to claim 2, wherein the polyester-based fiber (A) is at least one polymer selected from the group consisting of polyethylene terephthalate, polypropylene terephthalate, polybutylene terephthalate, polyester that includes polyethylene terephthalate as a main component and is copolymerized with ethylene glycol ether of bisphenol A, polyester that includes polyethylene terephthalate as a main component and is copolymerized with 1,4-cyclohexanedimethanol, polyester that includes polyethylene terephthalate as a main component and is copolymerized with dihydroxyethyl 5-sodium sulfoisophthalate, a polymer alloy of polyethylene terephthalate and polyethylene naphthalate, a polymer alloy of polyethylene terephthalate and polyarylate, and a polymer alloy of polyethylene terephthalate and polycarbonate.

4. The fiber-containing product for hair according to claim 1, wherein the polyester-based fiber (A) has a heat shrinkage factor at 180° C. of 5% or less.

5. The fiber-containing product for hair according to claim 1, wherein the regenerated collagen fiber (B) is a regenerated collagen fiber that includes 8 to 20 wt % of an aluminum compound on an aluminum oxide basis.

6. The fiber-containing product for hair according to claim 1, wherein the regenerated collagen fiber (B) has a heat shrinkage factor at 160° C. of 5% or less.

7. The fiber-containing product for hair according to claim 1, wherein the polyester-based fiber (A) has a limiting oxygen index (LOI value) of 25 or greater.

8. The fiber-containing product for hair according to claim 1, wherein the polyester (A) is a polyester that further includes a phosphorus-based flame retardant (D) and/or a bromine-based flame retardant (E).

9. The fiber-containing product for hair according to claim 8, wherein the phosphorus-based flame retardant (D) is at least one compound selected from the group consisting of a phosphate-based compound, a phosphonate-based compound, a phosphinate-based compound, a phosphine oxide-based compound, a phosphonite-based compound, a phosphinite-based compound, a phosphine-based compound, a condensed phosphoric acid ester compound, a phosphoric acid ester amide compound, and an organic cyclic phosphorus-based compound.

10. The fiber-containing product for hair according to claim 8, wherein the bromine-based flame retardant (E) is at least one compound selected from the group consisting of a bromine-containing phosphoric acid ester-based flame retardant, a brominated polystyrene-based flame retardant, a brominated benzyl acrylate-based flame retardant, a brominated epoxy-based flame retardant, a brominated polycarbonate-based flame retardant, a tetrabromobisphenol A derivative, a bromine-containing triazine-based compound, and a bromine-containing isocyanuric acid-based compound.

11. The fiber-containing product for hair according to claim 1, wherein at least one fiber selected from the polyester-based fiber (A) and the regenerated collagen fiber (B) includes at least one fine particle selected from an organic fine particle (F) and an inorganic fine particle (G).

12. The fiber-containing product for hair according to claim 11, wherein the organic fine particle (F) is at least one selected from the group consisting of polyarylate, polyamide, fluorocarbon resin, silicone resin, cross-linked acrylic resin, and cross-linked polystyrene.

13. The fiber-containing product for hair according to claim 11, wherein the inorganic fine particle (G) is at least one selected from the group consisting of calcium carbonate, silicon oxide, titanium oxide, aluminum oxide, zinc oxide, talc, kaoline, montmorillonite, bentonite, and mica.

14. A head dressing product comprising the fiber-containing product for hair formed of 90 to 10 parts by weight of polyester-based fiber (A) and 10 to 90 parts by weight of regenerated collagen fiber (B) that includes an aluminum compound, the total of the (A) and the (B) being 100 parts by weight.

15. The head dressing product according to claim 14, wherein the head dressing product is a weave, wig, toupee, hair extension or hair accessory.

16. The fiber-containing product for hair according to claim 1, comprising 85 to 15 parts by weight of the polyester-based fiber (A) and 15 to 85 parts by weight of the regenerated collagen fiber (B) that includes an aluminum compound.

17. The fiber-containing product for hair according to claim 16, comprising 75 to 15 parts by weight of the polyester-based fiber (A) and 25 to 85 parts by weight of the regenerated collagen fiber (B) that includes an aluminum compound.

18. The fiber-containing product for hair according to claim 1, wherein the polyester-based fiber (A) has a single fiber fineness ranging from 20 to 100 dtex, and the regenerated collagen fiber (B) has a single fiber fineness ranging from 30 to 90 dtex.

19. The fiber-containing product for hair according to claim 11, wherein the organic fine particle (F) and the inorganic fine particle (G) have an average particle size ranging from 0.1 to 15 μm.

20. The fiber-containing product for hair according to claim 11, wherein at least one particle selected from the organic fine particle (F) and the inorganic fine particle (G) is added in an amount of 0.1 to 5 parts by weight relative to 100 parts by weight of the polyester-based fiber (A) or the regenerated collagen fiber (B).

21. The fiber-containing product for hair according to claim 1, wherein the fiber-containing product for hair has flame retardancy that shows a combustion time of less than 5 seconds, the combustion time being a combustion time after a 20 mm flame is brought into contact with a fixed filament having an effective length of 120 mm for 3 seconds, and then removed.
